(19) United States
(12) Patent Application Publication
(10) Pub. No.: US 2026/0133046 A1
(43) Pub. Date: May 14, 2026

(54) HIGH-PRECISION MAPPING METHOD FOR UNDERGROUND POOR TEXTURE SPACE BASED ON MOBILE-FIXED COLLABORATIVE DEVIATION CORRECTION

(71) Applicant: Tongji University, Shanghai (CN)

(72) Inventors: Gang Li, Shanghai (CN); Bin He, Shanghai (CN); Jiayi Hu, Shanghai (CN); Runjie Shen, Shanghai (CN)

(21) Appl. No.: 19/026,592

(22) Filed: Jan. 17, 2025

(30) Foreign Application Priority Data
Nov. 13, 2024 (CN) 202411619174.6

(51) Int. Cl. G01C 21/00

(52) U.S. Cl. CPC G01C 21/3811; G01C 21/3848

(57) ABSTRACT

A high-precision mapping method for an underground poor texture space based on mobile-fixed collaborative deviation correction includes: acquiring sensor data of sensor nodes determined based on the structure of the underground poor texture space; calculating the initial position data of an UAV; receiving sensor data through the UAV, and generating position data of the UAV by combining the initial position data of the UAV and lidar detection data of the UAV; correcting the position data of the UAV through a segmented mobile-fixed collaborative odometer; acquiring point cloud data for describing the structure of underground poor texture space; performing data fusion on the sensor data, the initial position data of the UAV, the corrected position data of the UAV and the point cloud data to obtain fused data, and establishing a high-precision map of the underground poor texture space, with each sensor node used as a feature point in the mapping.

### CROSS REFERENCE TO RELATED APPLICATIONS

The present disclosure claims the priority to the Chinese patent application with the application No. 202411619174.6, entitled “HIGH-PRECISION MAPPING METHOD FOR UNDERGROUND POOR TEXTURE SPACE BASED ON MOBILE-FIXED COLLABORATIVE DEVIATION CORRECTION” and filed on Nov. 13, 2024 with the Chinese Patent Office, the contents of which are incorporated in the present disclosure by reference in their entirety.

### TECHNICAL FIELD

The present disclosure relates to the field of map construction technology, and in particular to a high-precision mapping method for an underground poor texture space based on mobile-fixed collaborative deviation correction.

### BACKGROUND ART

The high-precision mapping method for an underground poor texture space is a method for precise positioning and map construction (mapping) of underground scenes. Underground poor texture space refers to the areas in the underground environment that lack rich visual features (i.e., texture information), such as tunnels, mines, or subway stations. Due to factors such as insufficient illumination, monotonous colors, and similar surface structures, these spaces usually lack feature points that can be visually identified, making image-based positioning and mapping difficult. The high-precision mapping method for an underground poor texture space may achieve high-precision mapping in low-texture underground spaces.

The high-precision mapping method for an underground poor texture space based on mobile-fixed collaborative deviation correction is of great significance in modern urban planning, infrastructure construction, environmental protection, mining, disaster relief, archacological research and the development of smart cities. Especially in the development of smart cities, high-precision underground maps are crucial for smart transportation and smart facility management.

The construction and maintenance of some urban infrastructure require detailed underground pipeline networks and facility maps to reduce construction errors and accident risks.

However, in the underground poor texture space, due to insufficient illumination and single texture, it is difficult for visual sensors to extract sufficient feature points, resulting in low positioning and mapping precision. The sensors commonly used in traditional technology for simultaneous positioning and map construction in the underground environment have poor data stability in narrow spaces or complex terrain conditions, and cannot obtain continuous and precise map data. Due to the narrow and long underground tunnels, loop detection is difficult to achieve, and odometer errors are difficult to correct, resulting in the gradual accumulation of positioning errors, which in turn affects map precision.

### SUMMARY

In order to solve the technical problems existing in the prior art that in underground poor texture spaces, due to insufficient illumination and single texture, it is difficult for visual sensors to extract sufficient feature points, resulting in low positioning and mapping precision; the sensors commonly used in traditional technology for simultaneous positioning and map construction in the underground environment have poor data stability in narrow spaces or complex terrain conditions, and cannot obtain continuous and precise map data; and due to the narrow and long underground tunnels, loop detection is difficult to achieve, and odometer errors are difficult to correct, resulting in the gradual accumulation of positioning errors, which in turn affects map precision. The present disclosure provides a high-precision mapping method for an underground poor texture space based on mobile-fixed collaborative deviation correction.

The technical solutions provided by embodiments of the present disclosure are as follows.

### First Aspect

Embodiments of the present disclosure provide a high-precision mapping method for an underground poor texture space based on mobile-fixed collaborative deviation correction, including:
S1: acquiring sensor data of sensor nodes determined based on a structure of the underground poor texture space, where the sensor data includes structural data of the structure of the underground poor texture space and position data of the sensor nodes;
S2: acquiring positioning data of an unmanned aerial vehicle (UAV) in the underground poor texture space, and calculating initial position data of the unmanned aerial vehicle based on the positioning data;
S3: receiving the sensor data through the unmanned aerial vehicle, and generating position data of the unmanned aerial vehicle by combining the initial position data of the unmanned aerial vehicle and lidar detection data of the unmanned aerial vehicle;
S4: correcting the position data of the unmanned aerial vehicle through a segmented mobile-fixed collaborative odometer;
S5: the corrected unmanned aerial vehicle (i.e., the unmanned aerial vehicle after the correcting) acquiring point cloud data used to describe the structure of the underground poor texture space;
S6: performing data fusion on the sensor data, the initial position data of the unmanned aerial vehicle, the corrected position data of the unmanned aerial vehicle and the point cloud data to obtain fused data; and
S7: establishing a high-precision map of the underground poor texture space based on the fused data, with each of the sensor nodes used as a feature point during a mapping process.

### Second Aspect

Embodiments of the present disclosure provide a high-precision mapping system for an underground poor texture space based on mobile-fixed collaborative deviation correction, including:
a processor; and
a memory having computer-readable instructions stored thereon, where when the computer-readable instructions are executed by the processor, the high-precision mapping method for an underground poor texture space based on mobile-fixed collaborative deviation correction as in the first aspect is implemented.

### Third Aspect

Embodiments of the present disclosure provide a computer-readable storage medium having computer programs stored thereon, where when the programs are executed by a processor, the high-precision mapping method for an underground poor texture space based on mobile-fixed collaborative deviation correction as in the first aspect is implemented.

The beneficial effects brought about by the technical solutions of the embodiments of the present disclosure include at least the follows.

In the present disclosure, in a poor texture underground environment, the positioning information of the unmanned aerial vehicle is used to calculate the initial position data of the unmanned aerial vehicle, ensuring that the initial precision is high at the starting of mapping and reducing the pressure of subsequent correction. The sensor data is transmitted to the unmanned aerial vehicle, and combined with the lidar detection data of the unmanned aerial vehicle, to generate relatively accurate position data, enhancing data stability and enabling that continuous precise map data is acquired. Through correction by the segmented mobile-fixed collaborative odometer, the accumulation of positioning errors is effectively reduced, and the precision of the odometer is improved, and the unmanned aerial vehicle after the correction can acquire precise point cloud data, describe the structural characteristics of the underground space in detail, and provide high-quality spatial data support for subsequent map construction. Through data fusion, the deviation of each data source is eliminated, and high-precision fused data is generated to ensure the accuracy of the mapping. By taking the sensor nodes as feature points and integrating all fused data to construct a high-precision underground map, precise mapping of the poor texture underground space is achieved, effectively improving the management efficiency and application of the underground space.

### BRIEF DESCRIPTION OF DRAWINGS

In order to more clearly illustrate the technical solutions in the embodiments of the present disclosure, the following briefly introduces the drawings required for use in the description of the embodiments. Apparently, the drawings described below are only some embodiments of the present disclosure. For those skilled in the art, other drawings may be obtained based on these drawings without creative work.

FIG. 1 is a schematic flow chart of a high-precision mapping method for an underground poor texture space based on mobile-fixed collaborative deviation correction provided by embodiments of the present disclosure;

FIG. 2 is a schematic view of a deviation correction process of a segmented mobile-fixed collaborative odometer provided by embodiments of the present disclosure;

FIG. 3 is a schematic view of data fusion provided by embodiments of the present disclosure; and

FIG. 4 is a schematic structural view of a high-precision mapping system for an underground poor texture space based on mobile-fixed collaborative deviation correction provided by embodiments of the present disclosure.

### DETAILED DESCRIPTION OF EMBODIMENTS

The technical solutions of the present disclosure are described below in conjunction with the drawings.

In the embodiments of the present disclosure, words such as “exemplarily” and “for example” are used to indicate examples, illustrations or explanations. Any embodiment or design described as “example” in the present disclosure should not be interpreted as being more preferred or more advantageous than other embodiments or designs. Exactly, the use of the word “example” is intended to present the concept in a specific way. In addition, in the embodiments of the present disclosure, the meaning expressed by “and/or” may be refer to that there are both, or there may be either of the two.

In order to make the technical problems, technical solutions and advantages to be solved by the present disclosure clearer, a detailed description will be given below with reference to the drawings and embodiments.

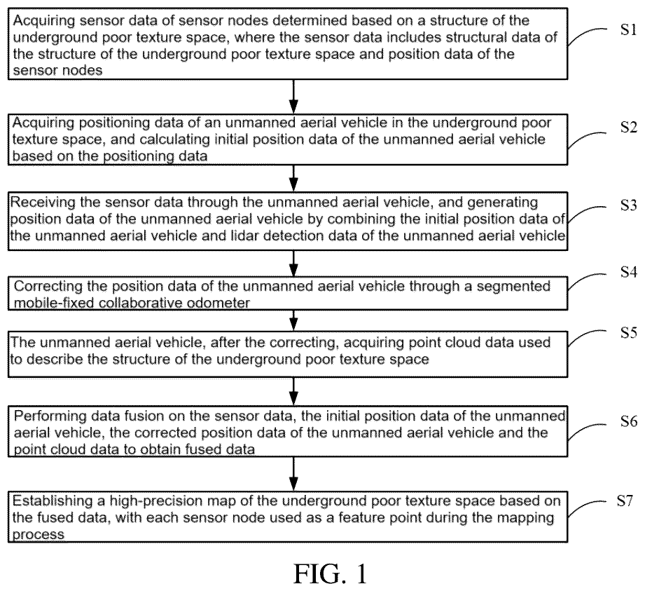

Referring to FIG. 1 of the specification, a schematic flow chart of a high-precision mapping method for an underground poor texture space based on mobile-fixed collaborative deviation correction provided by embodiments of the present disclosure is shown.

Embodiments of the present disclosure provide a high-precision mapping method for an underground poor texture space based on mobile-fixed collaborative deviation correction, including:

S1: acquiring sensor data of sensor nodes determined based on the structure of the underground poor texture space, where the sensor data includes structural data of the structure of the underground poor texture space and position data of the sensor nodes.

In the above, the sensor nodes refer to sensing devices (such as laser sensors, vibration sensors, etc.) arranged in the underground space, which are used to collect structural data and positioning information of the environment. The sensor data is the information collected by sensor nodes, including structural characteristics (such as building vibrations, surface features) of the underground space and position information of the nodes, which are used to assist positioning and mapping.

In a possible implementation, S1 specifically includes:
arranging the sensor nodes based on the structure of the underground poor texture space, by using a self-adaptive optimal arrangement strategy, and acquiring the sensor data.

In the above, the self-adaptive optimal arrangement strategy includes automatically adjusting the arrangement positions of the sensor nodes according to the structural characteristics (such as tunnel shape, wall distance, etc.) of the underground poor texture space, to maximize coverage range and information acquisition effect.

It should be noted that through the self-adaptive optimal arrangement strategy, the sensor nodes may efficiently cover key areas, avoid situations of over-dense or missing areas, acquire as much environmental data as possible under the situation of limited resources, improve data utilization efficiency, and significantly improve the precision and completeness of the mapping of the underground space.

In a possible implementation, the structural data of the structure of the underground poor texture space includes building vibration data and building structure data.

In the above, the building vibration data refers to the vibration information which is collected by the sensor nodes and reflects vibrations of buildings or structures in the underground space generated due to external factors (such as construction, geological activities, etc.). The building structure data is data which is acquired by sensors and describes the shapes, layouts and other physical characteristics of underground buildings or space structures.

It should be noted that by collecting the building vibration data and the building structure data, it can more accurately understand the physical state and stability of underground space and identify potential safety hazards. Real-time monitoring of the building vibration data helps to correct errors in positioning of the unmanned aerial vehicle, while the building structure data provides a stable reference basis for high-precision mapping, ensuring that the generated map has higher reliability and precision.

In a possible implementation, the position data of the sensor nodes includes the positions of the sensor nodes and the time when the sensor nodes send the sensor data.

Specifically, by precisely recording the position information and the time when data is sent of the sensor nodes, it is possible to perform spatiotemporal matching of data, filter and correct delays or errors in the data, and improve the precision and timeliness of the underground map.

It should be noted that by arranging the sensor nodes in the underground poor texture space, comprehensive structural data and position information can be acquired without relying on visual features, which effectively solves the problem of insufficient information in the poor texture environment. The self-adaptive arrangement of the sensor nodes ensures that key areas are covered, improves data stability and map precision, and provides a reliable data basis for subsequent high-precision mapping.

S2: acquiring the positioning data of the unmanned aerial vehicle in the underground poor texture space, and calculating the initial position data of the unmanned aerial vehicle based on the positioning data.

In the above, the positioning data refers to the position information that the unmanned aerial vehicle acquires through sensors (such as lidar, inertial measurement unit, etc.) in the underground poor texture space, and is used to determine the position of the unmanned aerial vehicle in the space. The initial position data refers to the specific position coordinates of the unmanned aerial vehicle at the starting point of mapping, calculated based on the positioning data, and provides a reference point for subsequent path and map construction.

In a possible implementation, S2 specifically includes:
acquiring the positioning data of the unmanned aerial vehicle in the underground poor texture space, and calculating the initial position data of the unmanned aerial vehicle by using an accelerometer and a gyroscope.

In the above, the accelerometer is a sensor that measures the acceleration changes of the unmanned aerial vehicle in individual axial directions, and infers the position changes by monitoring the acceleration during moving. The gyroscope is used to detect the angular velocity of the unmanned aerial vehicle and helps track its rotation and attitude changes.

It should be noted that by precisely acquiring the initial position data of the unmanned aerial vehicle, a reliable reference point may be determined at the beginning of mapping, reducing the cumulative error of subsequent positioning, providing a stable starting point for high-precision mapping, and enabling the unmanned aerial vehicle to navigate and map efficiently and accurately in the underground environment which lacks illumination and feature points, thus greatly improving the precision and consistency of the map.

S3: receiving the sensor data through the unmanned aerial vehicle and generating position data of the unmanned aerial vehicle by combining the initial position data of the unmanned aerial vehicle and the lidar detection data of the unmanned aerial vehicle.

In the above, the lidar detection data is the environmental depth and distance information acquired by the unmanned aerial vehicle through lidar, which helps the unmanned aerial vehicle identify spatial structures.

In a possible implementation, the receiving sensor data through the unmanned aerial vehicle specifically includes:

establishing a communication channel between the unmanned aerial vehicle and the sensor nodes through ZigBee low-power wireless communication.

In the above, ZigBee is a low-power, low-rate wireless communication protocol designed for short-distance, low-bandwidth device communication. It is often used in sensor networks and has the advantages of low power consumption, low cost, and flexible networking, etc. It is very suitable for use in scenarios with limited power and low signal demand. The communication channel refers to the wireless data transmission path established between the unmanned aerial vehicle and the sensor nodes. Through this channel, the unmanned aerial vehicle can receive environmental data sent by the sensor nodes in real time to support positioning and mapping.

The sensor data is received based on the communication channel.

It should be noted that by integrating the sensor data, initial position data and lidar detection data, high-precision unmanned aerial vehicle positions can be continuously generated in the underground environment lacking visual features, which not only enhances the positioning stability and precision, but also reduces the errors caused by position drift, ensuring more precise navigation and mapping of the unmanned aerial vehicle in the underground space, and providing guarantees for the integrity and detail richness of the final map.

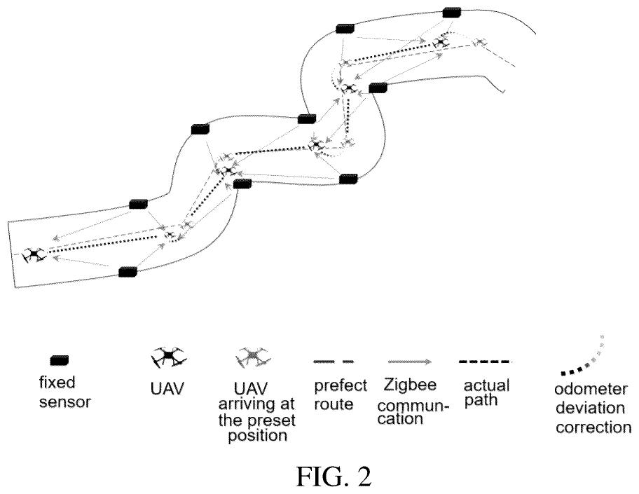

Referring to FIG. 2 of the specification, a schematic view of a deviation correction process of a segmented mobile-fixed collaborative odometer provided by embodiments of the present disclosure is shown.

As in FIG. 2, a process of the unmanned aerial vehicle performing odometer deviation correction in an underground poor texture space is shown. The figure shows the deviation between the actual flight trajectory (dashed line) and the predetermined ideal path (solid line) of the unmanned aerial vehicle in a complex path, as well as the fixed sensor node distribution and ZigBee communication path. The unmanned aerial vehicle receives the positioning information of the sensor nodes, realizes data transmission through ZigBee communication, and performs odometer correction at each predetermined position to reduce path deviation and ultimately achieve high-precision mapping.

S4: correcting the position data of the unmanned aerial vehicle through the segmented mobile-fixed collaborative odometer.

In the above, the segmented mobile-fixed collaborative odometer correction (i.e., the correction through the segmented mobile-fixed collaborative odometer) is a positioning correction method based on odometer error control. This method combines the mobile sensor (unmanned aerial vehicle) and fixed sensor nodes to perform collaborative positioning correction in segments to reduce the accumulation of positioning errors.

In a possible implementation, S4 specifically includes:
S401: acquiring relative positions of the unmanned aerial vehicle and the sensor node:

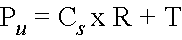

where Pᵤ represents the position of the unmanned aerial vehicle in the world coordinate system, Cₛ represents the coordinates of the sensor node in the world coordinate system, R represents the rotation matrix between the unmanned aerial vehicle and the sensor node, and T represents the translation vector between the unmanned aerial vehicle and the sensor node; and
S402: correcting the position data of the unmanned aerial vehicle through the segmented mobile-fixed collaborative odometer according to the relative positions of the unmanned aerial vehicle and the sensor node.

In a possible implementation, S402 specifically includes:
correcting the position data of the unmanned aerial vehicle when the timer interval of the segmented mobile-fixed collaborative odometer is greater than a preset timer interval and the distance between the sensor node and the unmanned aerial vehicle is less than a preset distance.

It should be noted that the segmented mobile-fixed collaborative correction effectively reduces the position drift of the unmanned aerial vehicle in a narrow or complex underground space. Through segmented adjustment, the unmanned aerial vehicle can acquire precise positioning data on each path, improve the stability and accuracy of the overall positioning while avoiding cumulative errors, and ensure that high-precision mapping can be achieved under various environmental conditions.

S5: acquiring the point cloud data used for describing the structure of the underground poor textures space through the corrected unmanned aerial vehicle.

In the above, the point cloud data is a three-dimensional spatial data set acquired by lidar or other ranging sensors, and usually contains a large number of spatial coordinate points (x, y, z). These points represent the surface and structure of objects in the environment and are densely and evenly distributed in the space. The point cloud data is used to accurately depict the geometric shape of the surface and structure of objects, and is usually used in three-dimensional modeling, map construction and object recognition.

It should be noted that the corrected position data of the unmanned aerial vehicle enhances the precision of the point cloud data, ensuring that the generated three-dimensional model is more accurate and can truly reflect the details and structure of the underground space. High-quality point cloud data supports detailed analysis and visualization of the complex underground environment, improving the reliability and practicality of the map.

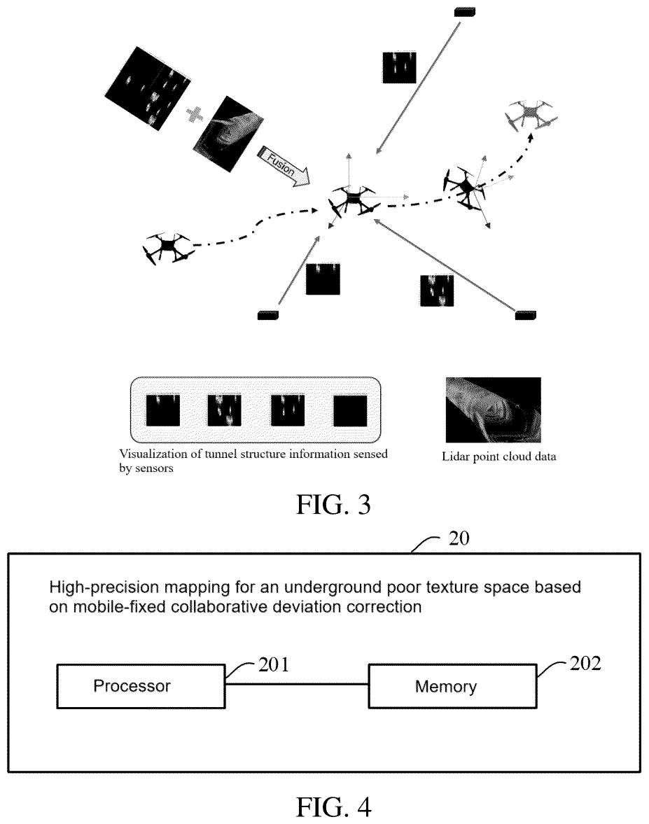

Referring to FIG. 3 of the specification, a schematic view of data fusion provided by embodiments of the present disclosure is shown.

As in FIG. 3, the process of achieving high-precision mapping through data fusion is shown. The figure shows that the unmanned aerial vehicle receives tunnel structure information through multiple fixed sensor nodes on the flight path. At the same time, the point cloud data generated by the lidar is also integrated into the positioning process of the unmanned aerial vehicle. The tunnel structure information of each sensor node and the point cloud data generated by the lidar are fused on the unmanned aerial vehicle to form a high-precision underground space map, thereby providing precise navigation reference for the unmanned aerial vehicle.

S6: performing data fusion on the sensor data, the initial position data of the unmanned aerial vehicle, the corrected position data of the unmanned aerial vehicle and the point cloud data to obtain fused data.

In the above, the data fusion refers to the comprehensive processing of multiple kinds of data (including the sensor data, the initial position data of the unmanned aerial vehicle, corrected position data of the unmanned aerial vehicle and the point cloud data) from different sources to produce a more accurate and reliable result.

It should be noted that through data fusion, the information provided by various sensors is fully utilized to ensure the accuracy and consistency of map construction. The corrected position data of the unmanned aerial vehicle is combined with the point cloud data to make the map have higher spatial resolution and precision.

S7: establishing a high-precision map of the underground poor texture space based on the fused data, with each sensor node used as a feature point during the mapping process.

It should be noted that, that each sensor node in the fused data is used as the feature point for mapping can significantly improve the construction quality of high-precision map, which not only makes up for the shortcomings of insufficient visual features in underground poor texture space, but also ensures that the integrity and spatial resolution of the map in structure and makes the final high-precision map more real and accurate.

The beneficial effects brought about by the technical solutions provided by the embodiments of the present disclosure include at least the follows.

In the present disclosure, in a poor texture underground environment, the positioning information of the unmanned aerial vehicle is used to calculate the initial position data of the unmanned aerial vehicle, ensuring that the initial precision is high at the starting of mapping and reducing the pressure of subsequent correction. The sensor data is transmitted to the unmanned aerial vehicle, and combined with the lidar detection data of the unmanned aerial vehicle, to generate relatively accurate position data, enhancing data stability and enabling that continuous precise map data is acquired. Through correction by the segmented mobile-fixed collaborative odometer, the accumulation of positioning errors is effectively reduced, and the precision of the odometer is improved, and the unmanned aerial vehicle after the correction can acquire precise point cloud data, describe the structural characteristics of the underground space in detail, and provide high-quality spatial data support for subsequent map construction. Through data fusion, the deviation of each data source is eliminated, and high-precision fused data is generated to ensure the accuracy of the mapping. By taking the sensor nodes as feature points and integrating all fused data to construct a high-precision underground map, precise mapping of the poor texture underground space is achieved, effectively improving the management efficiency and application of the underground space.

Referring to FIG. 4 of the specification, a schematic structural view of a high-precision mapping system for an underground poor texture space based on mobile-fixed collaborative deviation correction provided by the present disclosure is shown.

The present disclosure further provides a high-precision mapping system 20 for an underground poor texture space based on mobile-fixed collaborative deviation correction, which is applied to the above-mentioned high-precision mapping method for an underground poor texture space based on mobile-fixed collaborative deviation correction, including:
a processor 201; and
a memory 202, the memory 202 storing computer-readable instructions. When the computer-readable instructions are executed by the processor 201, the high-precision mapping method for an underground poor texture space based on mobile-fixed collaborative deviation correction as described in the method embodiments is implemented.

The high-precision mapping system 20 for an underground poor texture space based on mobile-fixed collaborative deviation correction provided by the present disclosure may execute the above-mentioned high-precision mapping method for an underground poor texture space based on mobile-fixed collaborative deviation correction, and achieve the same or similar technical effects. To avoid repetition, the present disclosure will not repeat them.

The technical effects brough about by the technical solutions provided by the embodiments of the present disclosure include at least the follows.

In the present disclosure, in a poor texture underground environment, the positioning information of the unmanned aerial vehicle is used to calculate the initial position data of the unmanned aerial vehicle, ensuring that the initial precision is high at the starting of mapping and reducing the pressure of subsequent correction. The sensor data is transmitted to the unmanned aerial vehicle, and combined with the lidar detection data of the unmanned aerial vehicle, to generate relatively accurate position data, enhancing data stability and enabling that continuous precise map data is acquired. Through correction by the segmented mobile-fixed collaborative odometer, the accumulation of positioning errors is effectively reduced, and the precision of the odometer is improved, and the unmanned aerial vehicle after the correction can acquire precise point cloud data, describe the structural characteristics of the underground space in detail, and provide high-quality spatial data support for subsequent map construction. Through data fusion, the deviation of each data source is eliminated, and high-precision fused data is generated to ensure the accuracy of the mapping. By taking the sensor nodes as feature points and integrating all fused data to construct a high-precision underground map, precise mapping of the poor texture underground space is achieved, effectively improving the management efficiency and application of the underground space.

It should also be understood that the memory in the embodiments of the present disclosure may be a volatile memory or a non-volatile memory, or may include both volatile and non-volatile memories. Among them, the non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of exemplary, not limiting description, many forms of random access memory (RAM) are available, such as static RAM (SRAM), dynamic random access memory (DRAM), synchronous DRAM (SDRAM), double data rate SDRAM (DDR SDRAM), enhanced SDRAM (ESDRAM), synchlink DRAM (SLDRAM), and direct rambus RAM (DR RAM).

The above embodiments may be all or partially implemented by software, hardware (such as circuit), firmware or any other combination. When implemented by using software, the above embodiments may be all or partially implemented in the form of a computer program product. The computer program product includes one or more computer instructions or computer programs. When the computer instructions or computer programs are loaded or executed on a computer, processes or functions described according to the embodiments of the present disclosure are all or partially generated. The computer may be a general-purpose computer, a special-purpose computer, a computer network, or other programmable device. The computer instructions may be stored in a computer-readable storage medium, or transmitted from one computer-readable storage medium to another computer-readable storage medium. For example, the computer instructions may be transmitted from one website, computer, server or data center to another website, computer, server or data center by wired (such as infrared, wireless, microwave, etc.) manner. The computer-readable storage medium may be any available medium that can be accessed by a computer or a data storage device such as a server or data center that contains one or more available media sets. The available medium may be a magnetic medium (for example, a floppy disk, a hard disk, a tape), an optical medium (for example, a DVD), or a semiconductor medium. The semiconductor medium may be a solid-state hard disk.

It should be understood that the term “and/or” herein is only used to describe the association relationship of associated objects, indicating that there may be three relationships. For example, A and/or B may indicate three situations: A exists alone, A and B both exist, and B exists alone, where A and B may be singular or plural. In addition, the character “/” herein generally indicates that the associated objects therebefore and thereafter are in an “or” relationship, but it may also indicate an “and/or” relationship, which may refer to the context for specific understanding.

In the present disclosure, “at least one” means one or more, and “plurality/multiple” means two or more. “At least one of the following (items)” or similar expression refers to any combination of these items, including any combination of single or plural items. For example, at least one of a, b, or c may mean: a, b, c, a-b, a-c, b-c, or a-b-c, where a, b, and c may be singular or plural.

It should be understood that in various embodiments of the present disclosure, the serial numbers of the above-mentioned processes do not mean the execution order. The execution order of the individual processes should be determined by its function and internal logic, and should not constitute any limitation on the implementation process of the embodiments of the present disclosure.

Those skilled in the art will appreciate that the units and algorithm steps of each example described in conjunction with the embodiments disclosed herein may be implemented in electronic hardware, or a combination of computer software and electronic hardware. Whether these functions are performed in hardware or software depends on the specific application and design constraint conditions of the technical solution. Professional and technical personnel may use different methods to implement the described functions for each specific application, but such implementation should not be considered to be beyond the scope of the present disclosure.

Those skilled in the art can clearly understand that for the convenient and brief description, the specific working processes of the above-described equipment, devices and units may refer to the corresponding processes in the aforementioned method embodiments and will not be repeated here.

In the several embodiments provided by the present disclosure, it should be understood that the disclosed devices, apparatuses and methods may be implemented in other ways. For example, the device embodiments described above are only schematic. For example, the division of the units is only a logical function division. There may be other division methods in actual implementation. For example, multiple units or components may be combined or integrated into another device, or some features may be ignored or not executed. Another point is that the mutual coupling or direct coupling or communication shown or discussed may be indirect coupling or communication through some interfaces, devices or units, which may be electrical, mechanical or in other forms.

The units described as separate components may or may not be physically separated, and the components displayed as units may or may not be physical units, that is, they may be located in one place or distributed on multiple network units. Some or all of the units may be selected according to actual needs to achieve the purpose of the solutions of the embodiments.

In addition, the individual functional units in individual embodiments of the present disclosure may be integrated into one processing unit, or the individual units may exist physically separately, or two or more units may be integrated into one unit.

If the functions are implemented in the form of software functional units and sold or used as independent products, they may be stored in a computer-readable storage medium. Based on this understanding, the technical solution of the present disclosure, or the part that contributes to the prior art or a part of the technical solution may be embodied in the form of a software product. The computer software product is stored in a storage medium, including several instructions for enabling a computer device (which may be a personal computer, server, or network device, etc.) to execute all or part of the steps of the methods described in various embodiments of the present disclosure. The aforementioned storage medium includes: U disk, mobile hard disk, read-only memory (ROM), random access memory (RAM), disk or optical disk, and other media that may store program codes.

Embodiments of the present disclosure provide a computer-readable storage medium having computer programs stored thereon. When the programs are executed by a processor, the high-precision mapping method for an underground poor texture space based on mobile-fixed collaborative deviation correction as described in the method embodiments is implemented.

The computer-readable storage medium provided by the present disclosure may achieve steps and effects of the high-precision mapping method for an underground poor texture space based on mobile-fixed collaborative deviation correction as described in the method embodiments above. To avoid repetition, the present disclosure will not repeat them.

The beneficial effects brought about by the technical solutions of the embodiments of the present disclosure include at least the follows.

In the present disclosure, in a poor texture underground environment, the positioning information of the unmanned aerial vehicle is used to calculate the initial position data of the unmanned aerial vehicle, ensuring that the initial precision is high at the starting of mapping and reducing the pressure of subsequent correction. The sensor data is transmitted to the unmanned aerial vehicle, and combined with the lidar detection data of the unmanned aerial vehicle, to generate relatively accurate position data, enhancing data stability and enabling that continuous precise map data is acquired. Through correction by the segmented mobile-fixed collaborative odometer, the accumulation of positioning errors is effectively reduced, and the precision of the odometer is improved, and the unmanned aerial vehicle after the correction can acquire precise point cloud data, describe the structural characteristics of the underground space in detail, and provide high-quality spatial data support for subsequent map construction. Through data fusion, the deviation of each data source is eliminated, and high-precision fused data is generated to ensure the accuracy of the mapping. By taking the sensor nodes as feature points and integrating all fused data to construct a high-precision underground map, precise mapping of the poor texture underground space is achieved, effectively improving the management efficiency and application of the underground space.

The above are only specific embodiments of the present disclosure, but the protection scope of the present disclosure is not limited thereto. Any person skilled in the art who is familiar with the art may easily think of changes or substitutions within the technical scope disclosed by the present disclosure, which should be included in the protection scope of the present disclosure. Therefore, the protection scope of the present disclosure shall be subjected to the protection scope of the claims.

There are a few points to note.

(1) The drawings of the embodiments of the present disclosure only involve structures related to the embodiments of the present disclosure. Other structures may refer to conventional designs.

(2) For the sake of clarity, in the drawings used to describe the embodiments of the present disclosure, the thickness of layers or areas is zoomed out or zoomed in, that is, these drawings are not drawn according to the actual scale. It may be understood that when an element such as a layer, film, area or substrate is referred to as being “on” or “under” another element, the element may be “directly” “on” or “under” another element or there may be intermediate elements.

(3) Without conflict, the embodiments of the present disclosure and the features in the embodiments may be combined with each other to obtain new embodiments.

The above are only specific embodiments of the present disclosure, but the protection scope of the present disclosure is not limited thereto. The protection scope of the present disclosure shall be subject to the protection scope of the claims.

1. A high-precision mapping method for an underground poor texture space based on mobile-fixed collaborative deviation correction, comprising:
S1: acquiring sensor data of sensor nodes determined based on a structure of the underground poor texture space, wherein the sensor data comprises structural data of the structure of the underground poor texture space and position data of the sensor nodes;
S2: acquiring positioning data of an unmanned aerial vehicle in the underground poor texture space, and calculating initial position data of the unmanned aerial vehicle based on the positioning data;
S3: receiving the sensor data through the unmanned aerial vehicle, and generating position data of the unmanned aerial vehicle by combining the initial position data of the unmanned aerial vehicle and lidar detection data of the unmanned aerial vehicle;
S4: correcting the position data of the unmanned aerial vehicle by a segmented mobile-fixed collaborative odometer;
S5: the unmanned aerial vehicle, after the correcting, acquiring point cloud data used for describing the structure of the underground poor texture space;
S6: performing data fusion on the sensor data, the initial position data of the unmanned aerial vehicle, the corrected position data of the unmanned aerial vehicle and the point cloud data to obtain fused data; and
S7: establishing a high-precision map of the underground poor texture space based on the fused data, with each of the sensor nodes used as a feature point in a mapping process,
wherein the S4 comprises:
S401: acquiring relative positions of the unmanned aerial vehicle and one of the sensor nodes: 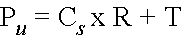
wherein Pᵤ represents a position of the unmanned aerial vehicle in a world coordinate system, Cₛ represents coordinates of the sensor node in the world coordinate system, R represents a rotation matrix between the unmanned aerial vehicle and the sensor node, and T represents a translation vector between the unmanned aerial vehicle and the sensor node; and
S402: correcting the position data of the unmanned aerial vehicle through the segmented mobile-fixed collaborative odometer according to the relative positions of the unmanned aerial vehicle and the sensor node, and
the S402 comprises:
correcting the position data of the unmanned aerial vehicle when a timer interval of the segmented mobile-fixed collaborative odometer is greater than a preset timer interval and a distance between one of the sensor nodes and the unmanned aerial vehicle is less than a preset distance.

2. The high-precision mapping method for an underground poor texture space based on mobile-fixed collaborative deviation correction according to claim 1, wherein the S1 comprises:
arranging the sensor nodes based on the structure of the underground poor texture space by using a self-adaptive optimal arrangement strategy, and acquiring the sensor data.

3. The high-precision mapping method for an underground poor texture space based on mobile-fixed collaborative deviation correction according to claim 1, wherein the structural data of the structure of the underground poor texture space comprises building vibration data and building structure data.

4. The high-precision mapping method for an underground poor texture space based on mobile-fixed collaborative deviation correction according to claim 1, wherein the position data of each of the sensor nodes comprises a position of the sensor node and the time when the sensor node sends the sensor data.

5. The high-precision mapping method for an underground poor texture space based on mobile-fixed collaborative deviation correction according to claim 1, wherein the S2 comprises:
acquiring the positioning data of the unmanned aerial vehicle in the underground poor texture space, and calculating the initial position data of the unmanned aerial vehicle by using an accelerometer and a gyroscope.

6. The high-precision mapping method for an underground poor texture space based on mobile-fixed collaborative deviation correction according to claim 1, wherein the receiving the sensor data through the unmanned aerial vehicle comprises:
establishing a communication channel between the unmanned aerial vehicle and the sensor nodes through ZigBee low-power wireless communication; and
receiving the sensor data based on the communication channel.

7. (canceled)

8. (canceled)

9. A high-precision mapping system for an underground poor texture space based on mobile-fixed collaborative deviation correction, comprising:
a processor; and
a memory having computer-readable instructions stored thereon, wherein when the computer-readable instructions are executed by the processor, the high-precision mapping method for an underground poor texture space based on mobile-fixed collaborative deviation correction according to claim 1 is implemented.

10. A computer-readable storage medium, having computer programs stored thereon, wherein when the programs are executed by a processor, the high-precision mapping method for an underground poor texture space based on mobile-fixed collaborative deviation correction according to claim 1 is implemented.

11. The high-precision mapping system for an underground poor texture space based on mobile-fixed collaborative deviation correction according to claim 9, wherein the S1 comprises:
arranging the sensor nodes based on the structure of the underground poor texture space by using a self-adaptive optimal arrangement strategy, and acquiring the sensor data.

12. The high-precision mapping system for an underground poor texture space based on mobile-fixed collaborative deviation correction according to claim 9, wherein the structural data of the structure of the underground poor texture space comprises building vibration data and building structure data.

13. The high-precision mapping system for an underground poor texture space based on mobile-fixed collaborative deviation correction according to claim 9, wherein the position data of each of the sensor nodes comprises a position of the sensor node and the time when the sensor node sends the sensor data.

14. The high-precision mapping system for an underground poor texture space based on mobile-fixed collaborative deviation correction according to claim 9, wherein the S2 comprises:
acquiring the positioning data of the unmanned aerial vehicle in the underground poor texture space, and calculating the initial position data of the unmanned aerial vehicle by using an accelerometer and a gyroscope.

15. The high-precision mapping system for an underground poor texture space based on mobile-fixed collaborative deviation correction according to claim 9, wherein the receiving the sensor data through the unmanned aerial vehicle comprises:
establishing a communication channel between the unmanned aerial vehicle and the sensor nodes through ZigBee low-power wireless communication; and
receiving the sensor data based on the communication channel.

16. (canceled)

17. (canceled)
